(19) United States
(12) Patent Application Publication
(10) Pub. No.: US 2005/0135202 A1
(43) Pub. Date: Jun. 23, 2005

(54) Magneto-optic optical miniaturized module and magneto-optic optical pickup device

(75) Inventor: Masaru Ogawa, Ikoma-shi (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/020,824

(22) Filed: Dec. 22, 2004

(30) Foreign Application Priority Data
Dec. 22, 2003 (JP) 2003-425636(P)

(51) Int. Cl. G11B 7/00

(52) U.S. Cl. 369/13.12; 369/13.01; 369/112.05

(57) ABSTRACT

An optical miniaturized module includes: a photodetector having a plurality of light receiving portions to receive light reflected by a magneto-optic storage medium; first polarization separation means for separating the reflected light and lasing light output from a source of light and traveling toward the medium; and a polarization hologram receiving the reflected light from the first polarization separation means to diffract at least a portion of the reflected light and guide diffracted light to the photodetector. The polarization hologram includes a plurality of diffraction areas diffracting the reflected light in different directions, and two of the diffraction areas provide diffracted beams directed to one of the light receiving portions.

This nonprovisional application is based on Japanese Patent Application No. 2003-425636 filed with the Japan Patent Office on Dec. 22, 2003 the entire contents of which are hereby incorporated by reference.

### BACKGROUND OF THE INVENTION

1. Field of the Invention

The present invention relates generally to optical miniaturized modules employed to optically record or reproduce information on or from optical disks or similar information storage media, and optical pickup devices equipped therewith, and particularly to magneto-optic optical miniaturized modules and magneto-optic optical pickup devices.

2. Description of the Background Art

FIG. 12 is a cross section of a conventional optical pickup device disclosed in Japanese Patent Laying-Open No. 08-297875.

The optical pickup device includes an optical miniaturized module and an objective lens. The module includes a source of light, polarization separation means and the like is formed integrally. Objective lens 113 is arranged between the module and a magneto-optic storage medium 130 and formed to focus laser light on the medium 130 recording surface.

The module includes a source of light 111 providing lased light, a grating 116 receiving the laser light from the source of light 111 to separate the light into three beams, and a base 140 arranged between the source of light 111 and objective lens 113. Base 140 has an upper surface provided with first polarization separation means 112 receiving light reflected from medium 130 to separate the reflected light in the direction of the radius of medium 130.

Base 140 has a lower surface provided with second polarization separation means 114a, 114b receiving the separated reflected light for further separation. Below the second polarization separation means 114a, 114b is arranged a photodetector 115 receiving the further separated reflected light. Photodetector 115 includes a group of light receiving portions 115a and a group of light receiving portions 115b.

The first polarization separation means 112 is implemented by a polarization hologram implemented by a double refraction diffraction grating. FIG. 13 is a perspective view of a polarization hologram 117 serving as the first polarization separation means 112. Polarization hologram 117 receives incident light and transmits an ordinary ray while diffracts an extra ordinary ray. Polarization hologram 117 has a grating 125, which is formed linearly and has a fixed pitch.

The first polarization separation means 112 or a polarization hologram is formed to provide a phase difference φ of approximately 70° for an ordinary ray and that of approximately 130° or approximately 230° for an extra ordinary ray. Furthermore, it is also formed to provide a 0th-order diffraction efficiency of 67% and +1st-order diffraction efficiencies in total of 27% for ordinary ray, and a 0th-order diffraction efficiency of 18% and ±1st-order diffraction efficiencies in total of 76% for extra ordinary ray. Medium 130 has information reproduced in accordance with Kerr effect. Medium 130 provides reflected light, which has a polarization plane rotated (Kerr rotated) in accordance with information recorded on medium 130. The first polarization separation means 112 formed to provide the above-described diffraction efficiencies provides a multiplied Kerr rotation angle of light reflected by medium 130. In other words, the first polarization separation means 112 has an enhancement function providing a multiplied Kerr rotation angle of light reflected by medium 130.

The second polarization separation means 114a, 114b is polarization separation means for detecting a behavior of a magneto-optical signal. The second polarization separation means 114a separates a +1st-order diffracted beam 112a formed by the first polarization separation means 112. The second polarization separation means 114b separates a −1st-order diffracted beam 112b formed by the first polarization separation means 112.

The second polarization separation means 114a, 114b, as well as the first polarization separation means 112, is implemented by a polarization hologram formed of a double refraction diffraction grating having such a structure as shown in FIG. 13. More specifically, the second polarization separation means 114a, 114b is implemented by a polarization hologram including parallel linear bars. The polarization hologram is formed to transmit an ordinary ray while diffract an extra ordinary ray. The second polarization separation means 114a, 114b is formed to provide a phase difference 4 of approximately 0° for ordinary ray and that of approximately 180° for extra ordinary ray.

FIG. 14 is a plan view of photodetector 115 in the FIG. 12 optical pickup device. Photodetector 115 is formed to receive ±1st-order diffracted beams 112a, 112b provided by the first polarization separation means 112. The reflected light is diffracted by the first polarization separation means 112 in the direction of the radius of medium 130 (see FIG. 12). The groups of light receiving portions 115a, 115b are aligned as seen in this direction. Groups 115a and 115b are provided to receive the +1st-order and −1st-order diffracted beams, respectively, from the first polarization separation means.

Group 115a includes light receiving portions 118, 119a, 119b and 120 to receive laser light divided by grating 116 into three beams in a direction perpendicular to that of the radius of medium 130. The group 115a light receiving portions receive a beam transmitted through the second polarization separation means and a −1st-order diffracted beam therefrom.

Similarly, group 115b includes light receiving portions 121, 122a, 122b and 123 to receive light divided by grating 116 into three beams. The group 115b light receiving portions receive a beam transmitted through the second polarization separation means and a +1st-order diffracted beam therefrom. As shown in FIG. 14, for each light receiving portion a spot R190 on which laser light impinges is indicated in the form of a circle for the sake of simplicity.

Group 115a at a row indicated by an arrow 114a0 receives a laser beam of light transmitted through the second polarization separation means 114a and at a row indicated by an arrow 114aB receives the −1st-order diffracted beam from the second polarization separation means 114a. Similarly group 115b at a row indicated by an arrow 114b0 receives a laser beam of light transmitted through the second polarization separation means 114b and at a row indicated by an arrow 114bA receives the +1st-order diffracted beam from the second polarization separation means 114b. Throughout the description of the background art, the left- and right-hand sides as seen in a direction X (the direction of the radius of the medium) in FIG. 14 are indicated as a “positive (+) side” and a “negative (−) side”, respectively.

Group 115a has a center light receiving portion, as seen in a direction Y (the medium's tangential direction), divided into light receiving portions 119a and 119b formed to be capable of receiving the second polarization separation means' transmitted and −1st-order diffracted beams, respectively, separately. Similarly, group 115b has light receiving portions 112a and 112b formed to be aligned in direction X.

Furthermore, light receiving portions 119a, 119b, 122a, 112b are divided by two lines parallel to direction X to detect a focus error signal by differential 3-division method. These portions are each divided into three portions to provide a center narrow portion and larger side portions sandwiching the center portion.

A reproduced magnet-optic signal MO1 is represented by the following equation:
MO1=(S119a−S119b)+(S122b−S122a) (1)
wherein a detected signal obtained at each light receiving portion is indicated by a reference character indicating the light receiving portion preceded by the letter “S”. In expression (1) the first term (S119a−S119b) is a differential signal by detected signals of the transmitted and −1st-order diffracted beams provided through the second polarization separation means 114a and the second term (S122b−S122a) is a differential signal by detected signals of the transmitted and +I st-order diffracted beams provided through the second polarization separation means 114b.

In a suitable embodiment described in Japanese Patent Laying-Open No. 08-297875 magnet-optic signal MO1 is formed of a signal obtained by detecting a differential between the transmitted and −1st-order diffracted beams of the second polarization separation means 114a and a signal obtained by detecting a differential between the transmitted and +1st-order diffracted beams of the second polarization separation means 114b. In the present invention a system employing expression (1) to form a magnet-optic signal will be referred to as a “first MO signal generation system.”

In FIG. 14 each light receiving portion's spot has a profile generally indicated by a circle for the sake of simplicity. In reality, however, the photodetector's light receiving portion receives a laser beam of light in a spot having a profile deformed rather than generally circular since diffracted light causes aberration. This deformation is attributed to aberration caused as reflected light is incident obliquely on the first or second polarization separation means formed of a substrate for example of lithium niobate. If the first or second polarization separation means includes a base formed for example of glass or resin or similar optical material, the aberration can further be increased.

With reference to FIGS. 15A and 15B, a simulation device is used to obtain a spot on a photodetector and in accordance with the spot a light receiving portion is formed for a photodetector, as shown in a plan view.

In the first MO signal generation system, for the group of light receiving portions 115a the second polarization separation means' transmitted and −1st-order diffracted beams alone are used, and for the group of light receiving portions 115b the second polarization separation means' transmitted and +1st-order diffracted beams alone are used. In other words, of the 1st-order diffracted beams of the second polarization separation means 114a and 114b, one diffracted beam is used for one group and the other diffracted beam for the other group.

For the photodetector, a photodetector can also be suggested that employs both +1st-order and −1st-order diffracted beams of the second polarization separation means 114a and 114b. A photodetector can also be proposed that has the group of light receiving portions 115a shown in FIG. 15A provided with a light receiving portion 119c indicated by a broken line, and the group of light receiving portions 115b shown in FIG. 15B provided with a light receiving portion 112c indicated by a broken line. This photodetector obtains a magneto-optic signal MO2 represented by the following expression:
MO2={S119a−(S119b+S119c)}+{S122a−(S122b+S122c)} (2)

In the following description a system employing expression (2) to obtain magneto-optic signal MO2 will be referred to as a “second MO signal generation system.”

Japanese Patent Laying-Open No. 08-297875 does not describe the second polarization separation means' diffraction efficiency. However the second polarization separation means' disclosed configuration in theory allows a 0th-order diffraction efficiency of 100% for ordinary ray and a +1st-order diffraction efficiencies of 40.5% for extra ordinary ray.

In detecting a differential signal of a magneto-optic signal, to reduce a common mode noise attributed to variation in intensity of laser light output from a source of light and variation in reflectance of a magneto-optic storage medium it is preferable that an information signal be detected by using ordinary and extra ordinary rays' components having substantially equal quantities of light.

If the information signal is obtained from a difference between a signal of a transmitted beam (a 0th-order diffracted beam) and a signal of a +1st-order diffracted beam or a difference between a signal of a transmitted beam and a signal of a −1st-order diffracted beam, as described in the first MO signal generation system, the ordinary and extra ordinary rays' components have their quantities of light at an unbalanced ratio of 100:45, and common mode noise is insufficiently reduced.

The angle formed by the direction of the optical axis of the second polarization separation means and that of polarization of incident light can be shifted from 45° to provide a ratio in quantity of light of 1:1. This, however, results in reduced carrier level and hence reduced carrier to noise ratio (C/N). Accordingly the imbalance of the ratio in quantity of light between the ordinary and extra ordinary rays' components is preferably reduced by adopting the second MO signal generation system obtaining an information signal from a difference between the sum of ±1st-order diffracted beams and a 0th-order diffracted beam.

In the second MO signal generation system ordinary and extra ordinary rays' components have their quantities of light at a ratio of 100:81, and as compared with the first MO signal generation system, the second MO signal generation system resolves the imbalance of the ratio in quantity of light and significantly reduces common mode noise. The second MO signal generation system, however, requires light receiving portions 119c and 122c, as shown in FIGS. 15A and 15B. Note that light receiving portions 119c and 112c each has a spot having a profile larger than those of the other spots. In particular, it is larger in the direction of the radius of the medium (or direction X). Accordingly, to receive these reflected lights, light receiving portions 119c and 122c need to have an increased surface area.

Internal to an optical pickup device, laser light emitted from a source of light is diff-used by a package or similar members and a portion thereof thus reaches the photodetector, resulting in a noise signal. In other words, stray light causes noise in a detected signal. Accordingly, it is preferable that a light receiving portion have a small surface area. However, light receiving portions 119c and 122c need to be formed to have a large surface area, and this causes an increased noise component and hence a decreased C/N.

As described above, conventional optical miniaturized modules and optical pickup devices can hardly achieve improved C/N. In particular, the conventional optical miniaturized modules and optical pickup devices can hardly adjust aberration of reflected light at the photodetector nor control a spot in position, profile and the like.

### SUMMARY OF THE INVENTION

The present invention contemplates an optical miniaturized module and optical pickup device capable of controlling the position, profile, length or width of a spot of reflected light at a photodetector. The present invention also contemplates an optical miniaturized module and optical pickup device that can provide improved C/N.

The present optical miniaturized module includes: a photodetector having a plurality of light receiving portions to receive light reflected by a magneto-optic storage medium; a first polarization separation element separating the reflected light and lasing light output from a source of light and traveling toward the medium; and a second polarization separation element receiving the reflected light from the first polarization separation element to diffract at least a portion of the reflected light and guide diffracted light to the photodetector, the second polarization separation element including a diffraction element having a plurality of diffraction areas, the diffraction element being formed to diffract the reflected light through the diffraction areas in different directions, the diffraction element being formed such that two of the diffraction areas provide diffracted beams directed to one of the light receiving portions. The module can control a position, profile, length or width of a spot on the photodetector.

In the present invention preferably the diffraction element includes first and second diffraction areas and is formed to allow both of +1st-order diffracted beams of the first diffraction area, both of 1st-order diffracted beams of the second diffraction area, and beams transmitted through the first and second diffraction areas to align on the photodetector generally in a straight line. The photodetector can receive a plurality of above-described spots spaced by a reduced distance so that the light receiving portion can have a reduced surface area and C/N can also be improved.

In the present invention preferably the diffraction element includes first and second diffraction areas and is formed such that of a set of a +1st-order diffracted beam of the first diffraction area and a −1st-order diffracted beam of the second diffraction area and a set of a −1st-order diffracted beam of the first diffraction area and a +1st-order diffracted beam of the second diffraction area, at least one set has its two diffracted beams at least partially overlapping at the light receiving portion. The photodetector can receive the above described spot reduced in area. The light receiving portion can have a reduced surface area and C/N can also be improved.

In the present invention preferably the diffraction element is divided by a line into two areas one having a grating smaller in pitch than the other's grating, the gratings being formed substantially along the line and curved to be concave or convex as seen in a direction from the one to the other areas. The photodetector can receive reflected lights such that they are adjacent, overlap and the like. The light receiving portion can have a reduced surface area and C/N can also be improved.

In the present invention preferably the diffraction element includes first and second lines orthogonal to each other and the second line defines two diffraction areas, one being further divided by the first line into first and second diffraction areas, and the other being further divided by the first line into third and fourth diffraction areas. The photodetector can receive spots of light such that they are adjacent, overlap and the like. The light receiving portion can have a reduced surface area and C/N can also be improved.

In the present invention preferably the diffraction element is formed such that of a set of a +1st-order diffracted beam of the first diffraction area and a +1st-order diffracted beam of the second diffraction area and a set of a −1st-order diffracted beam of the first diffraction area and a −1st-order diffracted beam of the second diffraction area, at least one set has its two diffracted beams at least partially overlapping at the light receiving portion. Alternatively, the diffraction element is formed such that of a set of a +1st-order diffracted beam of the third diffraction area and a +1st-order diffracted beam of the fourth diffraction area and a set of a −1st-order diffracted beam of the third diffraction area and a −1st-order diffracted beam of the fourth diffraction area, at least one set has its two diffracted beams at least partially overlapping at the light receiving portion. The light receiving portion can have a reduced surface area and C/N can also be improved.

In the present invention preferably the diffraction element includes a polarization hologram. By changing the polarization hologram's grating in configuration or the like, each diffraction area's diffracted beam can readily be adjusted in direction and/or the like.

In the present invention preferably the polarization hologram has a grating at least partially curved. The photodetector can receive a spot further reduced in area so that further improved C/N can be achieved.

In the present invention preferably the photodetector is formed to receive at one of the light receiving portions one of beams transmitted through the second polarization separation element and ±1st-order diffracted beams corresponding to one of the beams transmitted through the second polarization separation element. The photodetector can have a reduced number of light receiving portions and hence a simplified structure. Furthermore the photodetector can also be miniaturized.

In the present invention preferably the module includes a magneto-optic signal detector obtaining a differential signal between a detected signal of a diffracted beam of the second polarization separation element and a detected signal of a beam transmitted through the second polarization separation element. This allows the present invention to be applied to the above-described optical miniaturized module including the above magnet-optic signal detector.

The present optical pickup device includes the above optical miniaturized module. The device can control a position, profile, length or width of a spot on the photodetector. The device can also provide improved C/N.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross section of an optical pickup device in a first embodiment.

FIGS. 2A and 2B are a plan view and a schematic diagram, respectively, of a polarization hologram serving as second polarization separation means, and FIG. 2C is a schematic cross section for illustrating the polarization hologram's function.

FIGS. 3A and 3B are a plan view of a photodetector in the first embodiment.

FIG. 4 is a schematic cross section of an optical pickup device in a second embodiment.

FIG. 5 is a diagram for illustrating a polarization hologram arranged at an optical substrate in the second embodiment to initially diffract reflected light.

FIG. 6 is a plan view of one of polarization holograms in the second embodiment.

FIG. 7 is a plan view of one of photodetectors in the second embodiment.

FIGS. 8A and 8B are plan and schematic views, respectively, of a one of polarization holograms in the second embodiment serving as second polarization separation means.

FIG. 9 is a plan view of another photodetector in the second embodiment.

FIG. 10 is a plan view of a polarization hologram in conventional art serving as second polarization separation means.

FIG. 11 is a plan view of a photodetector corresponding to the second polarization separation means in conventional art.

FIG. 12 is a cross section of a conventional optical pickup device.

FIG. 13 is a view for illustrating a polarization hologram.

FIG. 14 is a plan view of a photodetector of an optical pickup device in conventional art.

FIGS. 15A and 15B are an enlarged plan view of a conventional photodetector.

### DESCRIPTION OF THE PREFERRED EMBODIMENTS

### First Embodiment

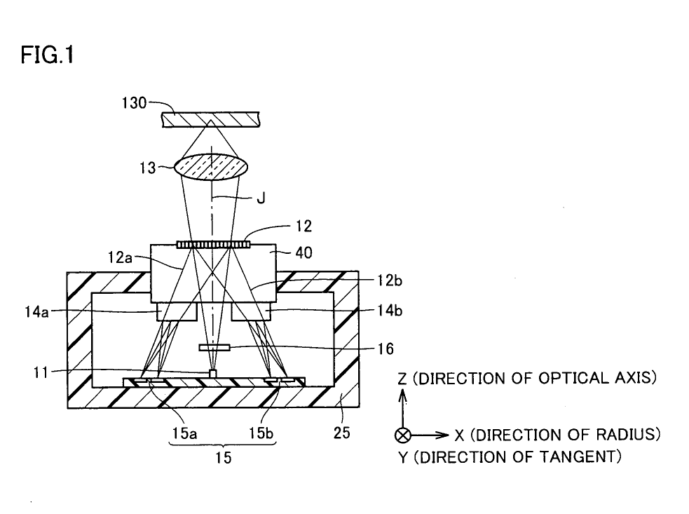

With reference to FIGS. 1-3B an optical miniaturized module and optical pickup device in a first embodiment of the present invention will be described.

FIG. 1 is a schematic cross section of the optical pickup device in the present embodiment and a magneto-optic storage medium. Throughout the description, terms such as “upper”, “lower” and other similar terms do not indicate absolute directions. Rather, they indicate various members' positional relationships.

The optical miniaturized module is formed integral with a package 25 having a substantially rectangular profile as seen in a plane, and formed in the form of a box so that it can internally accommodate each member. In package 25 at a lower portion is arranged a source of light 11 to lase light upward. Over the source of light 11 is arranged a grating 16 to divide the lasing light into three beams. Grating 16 is formed in a flat plate.

Package 25 has an upper portion provided with a base 40 having an internal portion hollowed and an upper surface provided with first polarization separation means implemented by a polarization hologram 12 formed to transmit the lasing light received from the source of light 11 while diffract reflected light received from the medium. In the present embodiment a diffracted beam on the left hand of FIG. 1 is a +1st-order diffracted beam 12a of polarization hologram 12 and a diffracted beam on the right hand of the figure is a −1st-order diffracted beam 12b of polarization hologram 12 in a direction, hereinafter indicated by “X”, optically corresponding to that of the radius of the medium as it rotates.

On a lower surface of base 40 on optical paths of the ±1st-order diffracted beams of polarization hologram 12 second polarization separation means implemented by diffraction elements are implemented by polarization holograms 14a and 14b arranged to sandwich the laser light's optical axis J and formed to diffract at least a portion of reflected light.

In package 25 at a lower portion is arranged a photodetector 15 receiving ±1st-order diffracted and transmitted beams of the second polarization separation means or polarization holograms 14a, 14b. The second polarization separation means is provided to diffract at least a portion of reflected light received from the first polarization separation means and guide the diffracted light to photodetector 15. Photodetector 15 has a group of light receiving portions 15a and a group of light receiving portion 15b arranged to receive +1st-order and −1st-order diffracted beams 12a and 12b, respectively. Polarization holograms 14a, 14b are each arranged on an optical path of reflected light immediately in front of photodetector 15.

Base 40 is internally hollowed and formed to have a height (or a length in a direction Z) of 1.45 mm. An optical substrate 3 has a lower surface spaced from the light receiving portion by a distance (in direction Z) of approximately 0.56 mm. The source of light 11 is adapted to output laser light of 785 nm.

The optical miniaturized module underlies an objective lens 13 arranged to focus light at the medium 130 recording surface. The optical pickup device includes objective lens 13 and the optical miniaturized module.

The first polarization separation means or polarization hologram 12 is similar to a conventional polarization hologram. For example, as described in Japanese Patent Laying-Open No. 08-297875, it has a surface provided with parallel bars having a substantially fixed pitch.

In the present embodiment polarization hologram 12 is, as shown in FIG. 13, formed such that an optical substrate 117a of lithium niobate provided with a grating 125 has a thickness t of 0.5 mm. A lithium niobate substrate provides an index of refraction of 2.6 for ordinary ray and an index of refraction of 2.18 for extra ordinary ray. Similarly, polarization hologram 14a, 14b has an optical substrate of lithium niobate having a thickness of 0.5 mm. Each polarization hologram's grating including a proton exchange layer has a negligible thickness.

The first polarization separation means is only required to separate reflected light received from the medium from the lasing light traveling toward the medium, and other than the above may for example include a polarization beam splitter. Furthermore in the present embodiment the first polarization separation means is implemented by a polarization hologram having an enhancement function.

The optical miniaturized module in the present embodiment is distinguished from a conventional optical miniaturized module by a configuration of polarization hologram 14a, 14b and that of photodetector 15.

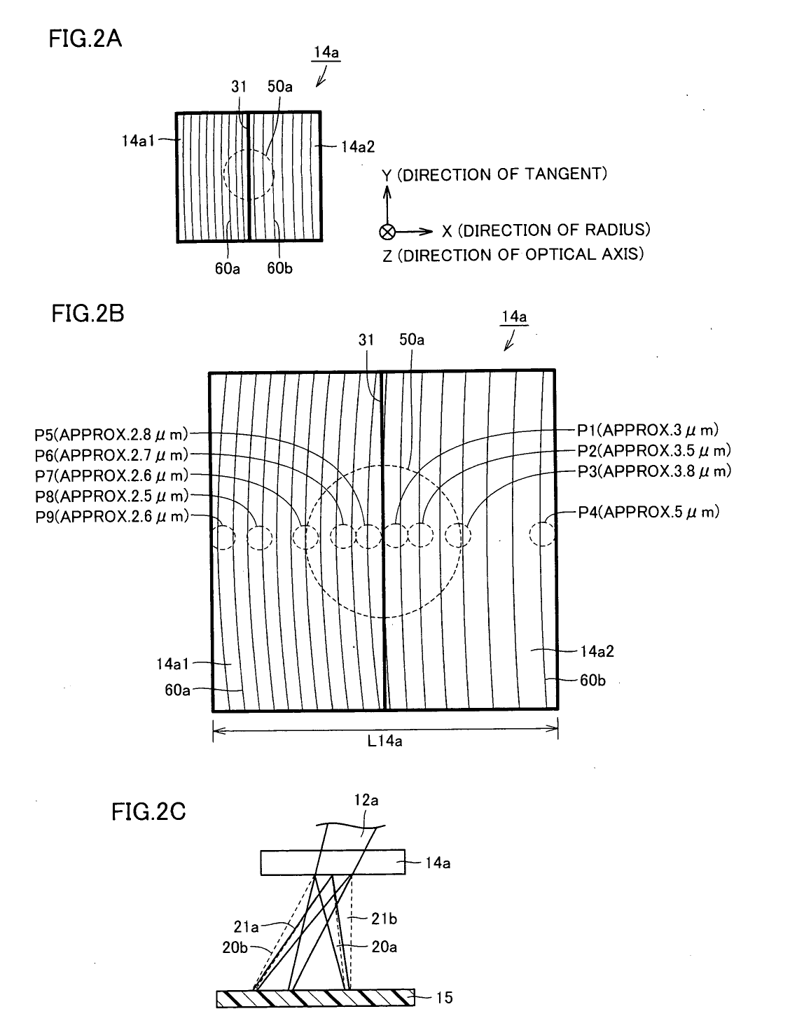

FIGS. 2A-2C are diagrams for illustrating polarization hologram 14a serving as the second polarization separation means. FIG. 2A is a plan view thereof. Polarization hologram 14a is divided by a line 31 serving as a border into first and second diffraction areas 14a1 and 14a2. That is, polarization hologram 14a has two diffraction areas. Line 31 is parallel to a direction Y optically corresponding to a direction perpendicular to that of the radius of the medium as seen when it rotates. Polarization hologram 14a is arranged to have the first diffraction area 14a1 farther from the center of the optical miniaturized module.

Furthermore, polarization hologram 14a is arranged to substantially bisect +1st-order diffracted beam 12a of polarization hologram 12 of FIG. 1 by line 31. In FIG. 2A, polarization hologram 14a is arranged so that line 31 bisects an area 50a receiving the +1st-order diffracted beam of polarization hologram 12.

FIG. 2B is an enlarged schematic plan view of polarization hologram 14a. Polarization hologram 14a is formed to be generally square, as seen in a plane, with each side having a length L14a of 600 μm and have area 50a with a radius of 130-150 μm and provide an effective numerical aperture (NA) of 0.135.

In polarization hologram 14a the first and second areas 14a1 and 14a2 have gratings different in geometry and the like. More specifically, the first diffraction area 14a1 grating 60a has a smaller pitch than the second diffraction area 14a2 grating 60b. In other words, grating 60a is formed of bars spaced by a smaller distance than grating 60b is.

FIG. 2B indicates approximate values of pitches of the grating of polarization hologram 14a on a line (not shown) perpendicularly bisecting line 31 at areas P1-P9. The first area 14a1 grating 60a has a pitch of approximately 2.6 to 2.8 μm, whereas the second area 14a2 grating 60b has a pitch of approximately 3 to 5 μm. Thus the grating 60a is formed to be smaller in pitch than grating 60b.

The first and second diffraction areas 14a1 and 14a2 gratings have a tendency to have a pitch generally maintained or increased as seen toward the positive direction in direction X. (Although areas P9 through to P7 provide a slightly decreasing pitch, it is substantially maintained.)

Furthermore, while at line 31 serving as the border of the first and second areas 14a1 and 14a2 gratings 60a and 60b are interrupted, in each area grating 60a, 60b is not interrupted. For example, in each area, grating 60a, 60b have their pitches smoothly changing in direction X. Furthermore in each area grating 60a, 60b has smoothly changing curvature.

Furthermore in areas 14a1, 14a2 their respective gratings 60a, 60b are each formed of substantially parallel bars. Strictly, while the pitch of the grating on the line perpendicularly bisecting line 31 is slightly different from that of the grating at an end of polarization hologram 14a, in each area 14a1, 14a2 the bars are substantially parallel.

Furthermore in areas 14a1, 14a2 their respective gratings 60a, 60b are formed in symmetry with respect to the line (not shown) perpendicularly bisecting line 31.

Gratings 60a, 60b are each formed to have substantially the same direction as line 31. Furthermore, gratings 60a, 60b are slightly curved to protrude as seen at the second area 14a2 toward the first area 14a1, or in the negative direction as seen in direction X.

The second polarization separation means or polarization hologram 14b is formed such that its grating and that of polarization hologram 14a are in symmetry for example in geometry with respect to optical axis J of lased light emitted from the source of light 11 (see FIG. 1). Polarization hologram 14b also has first and second diffraction areas, and the second diffraction area, having a grating with a larger pitch, is arranged closer to the center of the optical miniaturized module.

Polarization hologram 12 is formed to diffract a main beam of light at an angle of approximately −18° (in the negative direction as seen in direction X). The polarization hologram 12+1st-order diffracted beam is incident on polarization hologram 14a at approximately −18°. Polarization hologram 14a is formed so that the first and second areas 14a1 and 14a2 diffract the main beam's +1st-order diffracted beam at setting angles of approximately −28° and approximately −9°, respectively. The setting angles are angles relative to a downward direction (the negative direction as seen in direction Z) in FIG. 1.

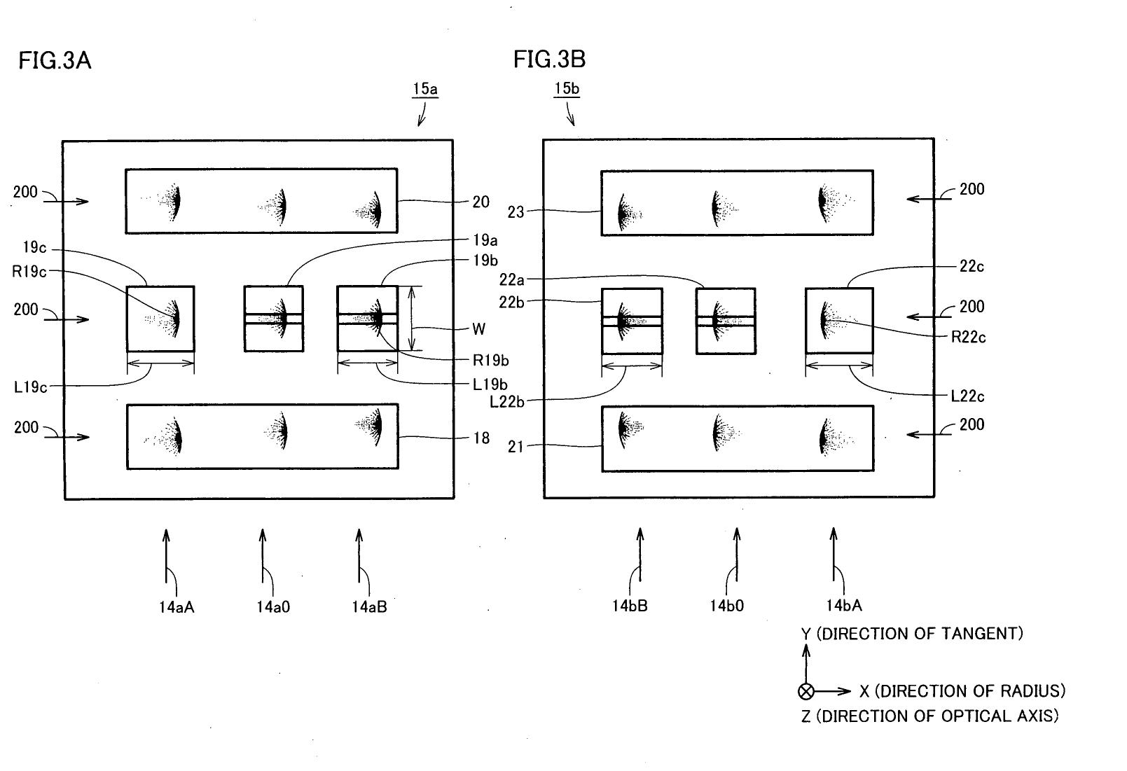

FIGS. 3A and 3B are a plan view of a photodetector in the present embodiment. More specifically, an optical pickup device is simulated to obtain reflected light at a photodetector and then in accordance with a spot's profile a light receiving portion is formed. Note that in the simulation's result matches an actual product with high precision. FIGS. 3A and 3B are plan views of the photodetector's groups of light receiving portion 15a and 15b, respectively.

The FIG. 3A group 15a and the FIG. 3B group 15b receive +1st-order and −1st-order diffracted beams 12a and 12b, respectively, of polarization hologram 12 in FIG. 1. Groups 15a, 15b each have its light receiving portions in three rows in direction X, as indicated by an arrow 200, to be capable of receiving light separated by the grating in three.

Group 15a includes light receiving portions 18, 19a, 19b, 19c and 20. Light receiving portions 18 and 20 as seen in a plane are each a rectangle having a length in direction X. Light receiving portions 19a and 19b as seen in a plane are each substantially square and also divided in three to detect a focus error signal by differential 3 division method. Each subarea has a length parallel to direction X. The three subareas form a center area and adjacent side areas. The center area is smaller in width than the adjacent side areas. The two adjacent side areas are substantially equal in area. Light receiving portion 19c is formed to be substantially square as seen in a plane.

The source of light provides lased light which is in turn divided by grating 16 in three, and the medium provides a reflection thereof which is in turn separated by the second polarization separation means or polarization holograms 14a, 14b (see FIG. 1). In the present embodiment the groups of light receiving portions 15a, 15b are formed to be capable of receiving transmitted and +1st-order diffracted beams of laser light passing through polarization holograms 14a, 14b.

In FIG. 3A, a beam transmitted through the second polarization separation means or polarization hologram 14a impinges on a row indicated by an arrow 14a0. A +1st-order diffracted beam therefrom impinges on a row indicated by an arrow 14aA. A −1st-order diffracted beam therefrom impinges on a row indicated by an arrow 14aB. In the present embodiment the photodetector is adapted to be capable of receiving nine subbeams of laser light to detect a signal.

Group 15B is formed to be capable of receiving a beam transmitted through and +1st-order diffracted beams provided by the second polarization separation means or polarization hologram 14b. More specifically, the transmitted, and +1st-order and −1st-order diffracted beams impinges on rows indicated by arrows 14b0, 14bA and 14bB, respectively.

Thus group 15b is also formed to be capable of receiving nine of subbeams of laser light. Furthermore, group 15b is formed in symmetry with group 15a with respect to optical axis J of the lased light. Light receiving portion 23 is in symmetry with light receiving portion 20, and light receiving portions 22a, 22b and 22c are in symmetry with light receiving portions 19a, 19b, and 19c, respectively. Light receiving portion 21 is in symmetry with light receiving portion 18.

Furthermore in the present embodiment the optical miniaturized module includes a magneto-optic signal detection means detecting a differential signal of detected signals obtained from the light receiving portions that correspond to the second polarization separation means' diffracted and transmitted beams.

In the present description a diffracted beam of polarization separation means implemented by a polarization hologram that should preferentially be determined in design (i.e., a diffracted beam of a side presetting a position at which a diffracted beam arrives) is set as a +1st-order diffracted beam, and a diffracted beam opposite the +1st-order diffracted beam is set as a −1st-order diffracted beam. As such, the symbols “+” and “−” in the “+1st-order diffracted beam” and “−1st-order diffracted beam” do not indicate absolute directions but rather relative directions. The −1st-order diffracted beam's angle of diffraction, a position at which the beam is collected, and the like are determined as depending on a polarization hologram designed with the +1st-order diffracted beam considered.

In FIG. 1 the source of light 11 emits lased light which is in turn separated by grating 16 into a main beam and two subbeams for a total of three beams, and pass through base 40 and is incident on objective lens 13. The laser light is focused by objective lens 13 at the medium 130 recording surface. Medium 130 reflects light which in turn again passes through objective lens 13 and is incident on and diffracted by polarization hologram 12. The first polarization separation means separates the lased light received from the source of light 11 and the reflected light received from medium 130.

Polarization hologram 12 forms +1st-order and −1st-order diffracted beams 12a and 12b which are in turn incident on polarization holograms 14a and 14b, respectively. These functions are similar to those of a conventional optical pickup device.

FIG. 2C illustrates +1st-order diffracted beam 12a of polarization hologram 12 incident on polarization hologram 14a. As shown in FIG. 2A, +1st-order diffracted beam 12a arrives at the center portion of polarization hologram 14a such that it is divided by line 31 in two. +1st-order diffracted beam 12a is diffracted in the polarization hologram 14a first and second diffraction areas 14a1 and 14a2.

The first diffraction area 14a1 provides a diffracted beam including +1st-order and −1st-order diffracted beams 20a and 20b and the second diffraction area 14a2 provides a diffracted beam including +1st-order and −1st-order diffracted beams 21a and 21b. In FIG. 2C +1st-order diffracted beams 20a, 21b are indicated by solid line and −1st-order diffracted beams 20b, 21b are indicated by broken line.

As shown in FIG. 2C, +1st-order diffracted beam 20a of the first diffraction area 14a1 and −1st-order diffracted beam 21b of the second diffraction area 14a2 overlap on a surface of photodetector 15, and so do −1st-order diffracted beam 20b of the first diffraction area 14a1 and +1st-order diffracted beam 21a of the second diffraction area 14a2. The second polarization separation means thus formed to allow diffracted beams to overlap allows a light receiving portion to receive a smaller spot. In the present embodiment, diffracted beams overlap at both of two spots adjacently sandwiching a transmitted beam. However, the present invention is not limited thereto, and diffracted beams may overlap at a spot of one side of a transmitted beam.

The second polarization separation means or polarization hologram 14a is formed so that each diffraction area can diffract reflected light in a different direction. Polarization hologram 14a has two diffraction areas different in angle of diffraction, and each diffraction area generates +1st-order diffracted beams. In polarization hologram 14a the first diffraction area 14a1 grating 60a has a smaller pitch than the second diffraction area 14a2 grating 60b. Such configuration allows +1st-order and −1st-order diffracted beams 20a and 21b to overlap on a surface (or a receiving portion) of photodetector 15, as shown in FIG. 2C. Furthermore, +1st-order and −1st-order diffracted beams 21a and 21b can also overlap on the photodetector. Furthermore in the present embodiment the two areas' gratings 60a and 60b are formed in substantially the same direction as line 31 and curved to be concave as seen from the first area 14a1 toward the second area 14a2. Such configuration can contribute to a further smaller spot.

The grating of each diffraction area of polarization hologram 14a is not limited in geometry, pitch and curvature to the present embodiment. It depends on the laser light's wavelength and angle of incidence, the polarization hologram's material and distance from the photodetector, and the like. Accordingly, it is adjusted as appropriate for use. For example in the present embodiment the gratings are generally parallel and curved to protrude as seen in one direction. However, they are not limited thereto, and one area may have a grating that is generally unparallel and having an inflection point to have a further curved geometry.

The other second polarization separation means or polarization hologram 14b is functionally similar to polarization hologram 14a, allowing the first diffraction area's +1st-order diffracted beam and the second diffraction area's −1st-order diffracted beam to overlap on the photodetector. Furthermore, the first and second diffraction areas' −1st-order and +1st-order diffracted beams, respectively, also overlap on the photodetector.

FIGS. 3A and 3B show a spot of laser light on each light receiving portions of group 15a and 15b. The spots of the rows indicated in FIG. 3A by arrows 14aA and 14aB are collected at a single location. For example, as for a center (or main) one of subbeam of laser light provided through grating 16, a spot R19b is a spot of the first diffraction area 14a1's +1st-order diffracted beam 20a and the second diffraction area 14a2's −1st-order diffracted beam 21b overlapping each other, as shown in FIG. 2C. Furthermore, a spot R19c is a spot of the second diffraction area 14a2's +1st-order diffracted beam 21a and the first diffraction area 14a1's −1st-order diffracted beam 20b overlapping each other, as shown in FIG. 2C. In the group of light receiving portions 15b each spot is formed in symmetry with the group of light receiving portion 15a with respect to optical axis J.

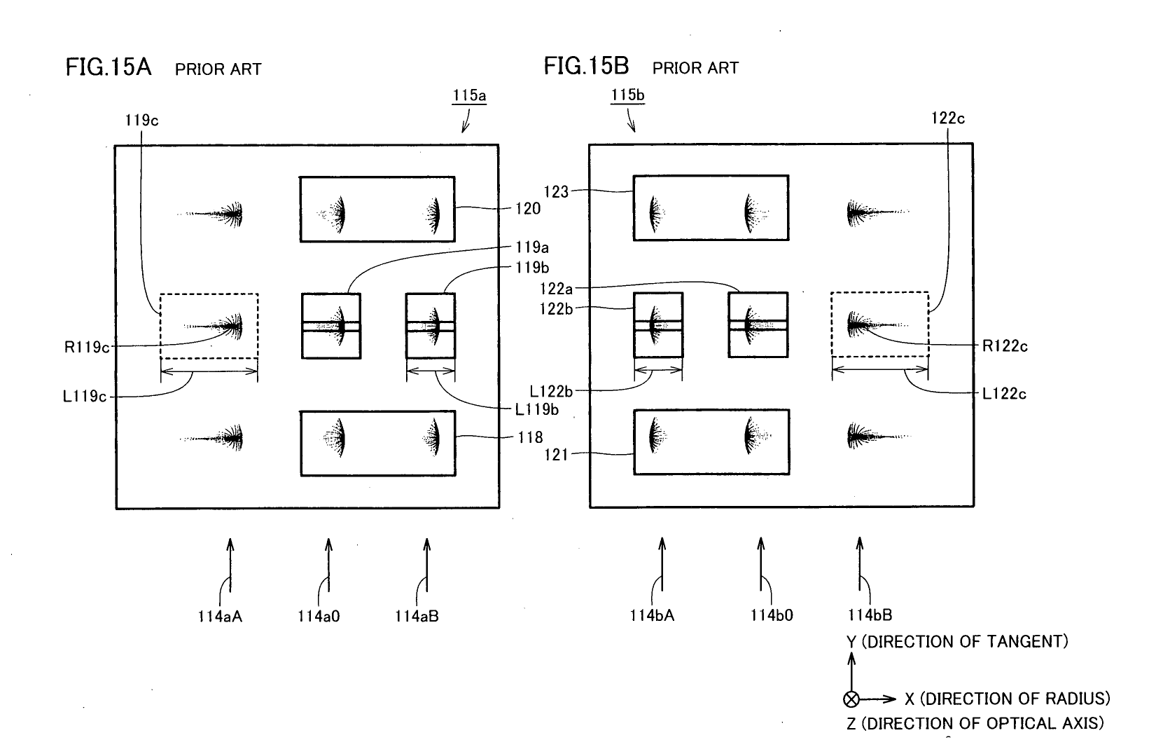

The FIGS. 15A and 15B conventional photodetector and the present photodetector will now be more specifically compared. The FIG. 15A group of light receiving portions 115a and the FIG. 3A group of light receiving portion 15a are compared. Spots of rows indicated by arrows 114a0 and 14a0, respectively, indicating light transmitted through a polarization hologram serving as the second polarization separation means are substantially identical as they are spots of transmitted light rather than diffracted light.

When the spots of the rows indicated by arrows 114aA and 14aA, respectively, located, at their respective groups of light receiving portions farther from the center of the optical miniaturized module are compared in profile the latter is smaller in length as seen in direction X. For example, the FIG. 3A spot R19c is smaller in length in direction X than the FIG. 15A spot R119c. Thus the present optical miniaturized module allows a reduced length of a one of spots at the photodetector. This is because rather than employing a conventional, simple linear grating as shown in FIG. 13 to uniformly separate the entirety of incident light, a diffraction area divided in two as shown in FIG. 2A is employed to diffract ±1st-order diffracted beams to allow laser light to provide a spot reduced in length and an angle of diffraction is determined to provide diffraction to allow diffracted beams to overlap on the photodetector to provide a spot reduced in length.

Furthermore, as shown in FIG. 2A, the present embodiment provides gratings 60a and 60b that are each curved. Such configuration can reduce the size of their respective diffracted beams at the photodetector. The gratings are curved in a direction and with a curvature, as depending on the relative, positional relationship between the second polarization separation means and the photodetector. As such, they are determined to focus light on the photodetector.

Table 1 indicates lengths and surface areas of light receiving portions of a conventional photodetector and those of light receiving portions of the photodetector of the present invention. A light receiving portion has a length (as seen in direction X) including a uniform margin of 20 μm from its respective spot's end, as the precision of the light receiving portion's attachment and a production error in producing the light receiving portion are considered. As each spot's width (in direction Y) is generally equivalent, each light receiving portion's width W is set to be 80 μm.

TABLE 1

| | Light Receiving | | Light Receiving | | |
|---|---|---|---|---|---|
| | Portion's | | Portion's Surface | | |
| | Length (μm) | | Area (μm²) | | |
| Present Invention | L19c | L19b | 19c | 19b | Total |
| | 86 | 77 | 6880 | 6160 | 13040 |
| Conventional Art | L119c | L119b | 119c | 119b | Total |
| | 125 | 62 | 10000 | 4960 | 14960 |

In accordance with the present invention light receiving portion 19c has a length L19c shorter than a length L119c of light receiving portion 119c of conventional art. In contrast, when the light receiving portion 19b length L19b is compared with the light receiving portion 19b length L119b, length L119b based on conventional art is shorter than length L19b of the present invention. When each light receiving portion's surface area is calculated, however, the present light receiving portions 19b and 19c total surface area (of 13,040 μm²) is 13% smaller than the conventional light receiving portion 119b and 119c total surface area (of 14,960 μm²). Length L22b and L22c of light receiving portions 22b and 22c of group 15b are also similar to group 15a, and the light receiving portions can provide a reduced total surface area.

Thus the present optical miniaturized module can selectively reduce a large spot in size and allows a photodetector as a whole to have light receiving portions having a reduced surface area. As a result, stray light causing noise can be received on a reduced surface area so that the present optical miniaturized module can provide better C/N than a conventional optical miniaturized module. Furthermore, the photodetector can be reduced in size and the optical miniaturized module can be miniaturized.

As described above, the second polarization separation means includes a diffraction element having a plurality of diffraction areas each diffracting reflected light in a different direction and more than one diffraction area's diffracted light is directed to one light receiving portion so that diffracted light's aberration can be adjusted for example to reduce a spot in length to control the spot in profile. Furthermore, their respective diffracted beams can be overlapped or the like to control the position of the diffracted beams on the photodetector and the length of the spot thereof

The present light receiving portions 18, 20 are formed to be larger in length as seen in direction X than conventional light receiving portions 118, 120. Light receiving portions 118, 120 are formed not to receive the +1st-order diffracted beam of the row indicated by arrow 114aA, whereas light receiving portions 18, 20 are formed to also receive ±1st-order diffracted beams of the row indicated by arrow 14aA. Such configuration can increase signals of light receiving portions 20 and 18 and hence a tracking error signal calculated therefrom.

Furthermore in the present embodiment the diffraction element is formed so that a plurality of diffracted beams overlap at light receiving portion. Such configuration can provide a spot having a smaller area and hence light receiving portion having a smaller surface area. Alternatively, the diffraction element may be formed so that a portion of a plurality of reflected lights does not overlap or none of them overlap and they are sufficiently adjacent to each other. Such configuration also allows light receiving portions to have a reduced surface area.

Furthermore, as shown in FIGS. 3A and 3B, both of the +1st-order diffracted beams of the first diffraction area and both of +1st-order diffracted beams of the second diffraction area, and the beams transmitted through the first and second diffraction areas align on the photodetector substantially in a straight line in a direction optically corresponding to direction X. The diffraction element formed to allow diffracted and transmitted beams to align in a straight line as described above allows light receiving portions to have a reduced total surface area.

Furthermore in the present embodiment the photodetector is formed to receive at a single light receiving portion the second polarization separation means' one transmitted beam and ±1st-order diffracted beams corresponding to the transmitted beam. For example, in FIG. 3A, three spots are received at a single light receiving portion 18. Such configuration can reduce the number of light receiving portions and simplify the configuration of the photodetector. Furthermore, the photodetector can also be miniaturized.

The present invention does not necessarily allow each and every light receiving portion to have a reduced spot area. A spot can be smaller, whereas another can be larger. Accordingly the second polarization separation means is formed to provide a reduced total surface area of light receiving portions receiving diffracted reflected light.

Furthermore, if diffracted beams provided by the second polarization separation means do not overlap on the photodetector, a light receiving portion can be divided to correspond to their respective spots and they can be added together in subsequently processing an optical signal. Preferably, however, the light receiving portion is formed so that diffracted beams to be added together collected at a plurality locations can be received at a single light receiving portion. Such configuration allows the photodetector to have a reduced number of light receiving portions and hence a simplified configuration, and can also contribute to increased productivity of optical miniaturized modules.

Furthermore the present optical pickup device includes the above described optical miniaturized module and an optical lens. Such configuration allows the optical pickup device to be capable of controlling a position, profile and the like of a spot of reflected light at a light receiving portion and also providing improved C/N.

### Second Embodiment

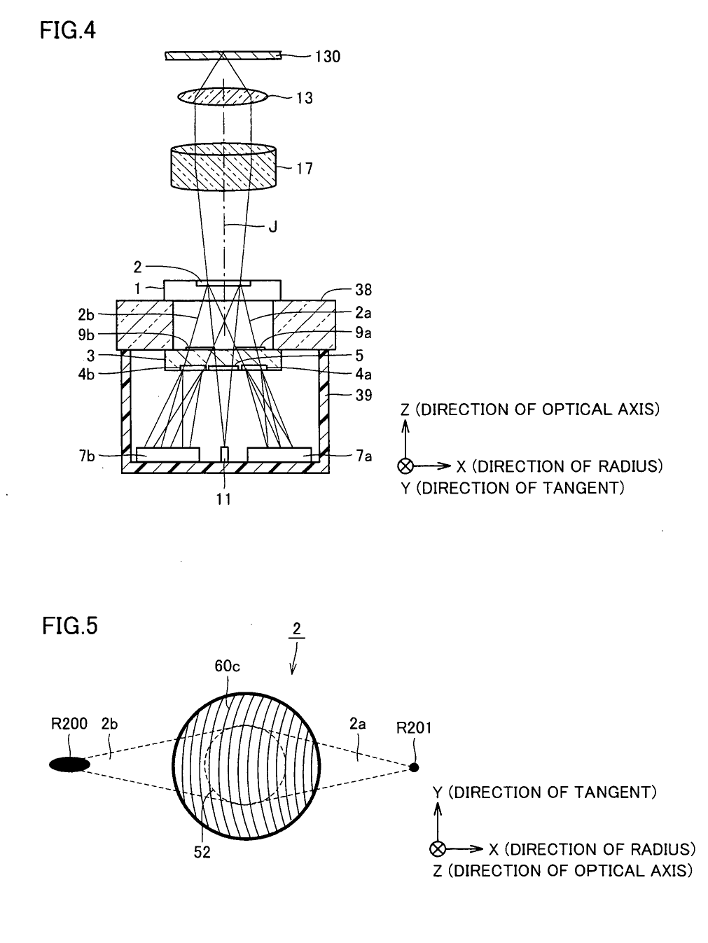

Reference will be made to FIGS. 4-11 to describe an optical miniaturized module and optical pickup device of the present invention in a second embodiment.

FIG. 4 is a schematic cross section of an optical pickup device in the present embodiment and a magneto-optic storage medium. The present optical miniaturized module includes a package 39, a support plate 38, an optical substrate 1, photodetectors 7a, 7b and the source of light 11. Package 39 is in the form of a box and underlies support plate 38. Support plate 38 has optical substrate 1 formed substantially at the center portion.

The source of light 11 and photodetectors 7a, 7b are arranged internal to package 39. The source of light 1.1 is arranged in package 39 on a bottom surface substantially at a center portion. Photodetectors 7a, 7b are arranged adjacent to the source of light 11. The source of light 11 is formed to be capable of providing lased light and on the laser beam's optical axis J a grating 5 is arranged to separate the laser light into three beams. Support plate 38 has a bottom surface provided with an optical substrate 3. Grating 5 is provided at a surface of optical substrate 3. On optical axis J at a surface of optical substrate 1 the first polarization separation means is implemented by a polarization hologram 2.

Magneto-optic storage medium 130 reflects light which is in turn diffracted by the first polarization separation means or polarization hologram 2 and thus separated into a +1st-order diffracted beam 2a and a −1st-order diffracted beam 2b. On an optical path of +1st-order diffracted beam 2a of polarization hologram 2 is arranged a phase plate 9a and the second polarization separation means implemented by a polarization hologram 4a. On an optical path of −1st-order diffracted beam 2b of polarization hologram 2 is arranged a phase plate 9b and the second polarization separation means implemented by a polarization hologram 4b. Support plate 38 has a hollowed portion at the center. Phase plates 9a and 9b are fixed by a fixture means (not shown) in the hollowed portion. Photodetectors 7a, 7b are arranged to be capable of receiving diffracted and transmitted beams from polarization holograms 4a, 4b.

In the present embodiment optical plates 1 and 3 each have a thickness of 0.35 mm and an index of refraction of 1.52. Support plate 38 has a thickness of 1.45 mm. Optical plate 3 has a bottom surface spaced from a light receiving portion by a distance (as seen in direction Z) of approximately 0.75 mm. The source of light 11 is adapted to provide lased light of 785 nm.

External to the optical miniaturized module on optical axis J are arranged a collimator lens 17 and objective lens 13 focusing the laser light at the medium 130 recording surface.

FIG. 5 is a plan view of polarization hologram 2 serving as the first polarization separation means. Polarization hologram 2 is circular as seen in a plane, and arranged such that an area 52 at which light reflected by medium 130 arrives is positioned substantially at the center. A grating 60c has bars substantially parallel to each other. Grating 60c extends in a direction substantially parallel to direction Y. Furthermore, grating 60c is curved to collect the +1st-order diffracted beams traveling toward photodetector 7a.

Furthermore, polarization hologram 2 is formed to provide a 0th-order diffraction efficiency of 77% and +1st-order diffraction efficiencies of 11% for P polarization, and a 0th-order diffraction efficiency of 0% and ±1st-order diffraction efficiencies of 44% for S polarization.

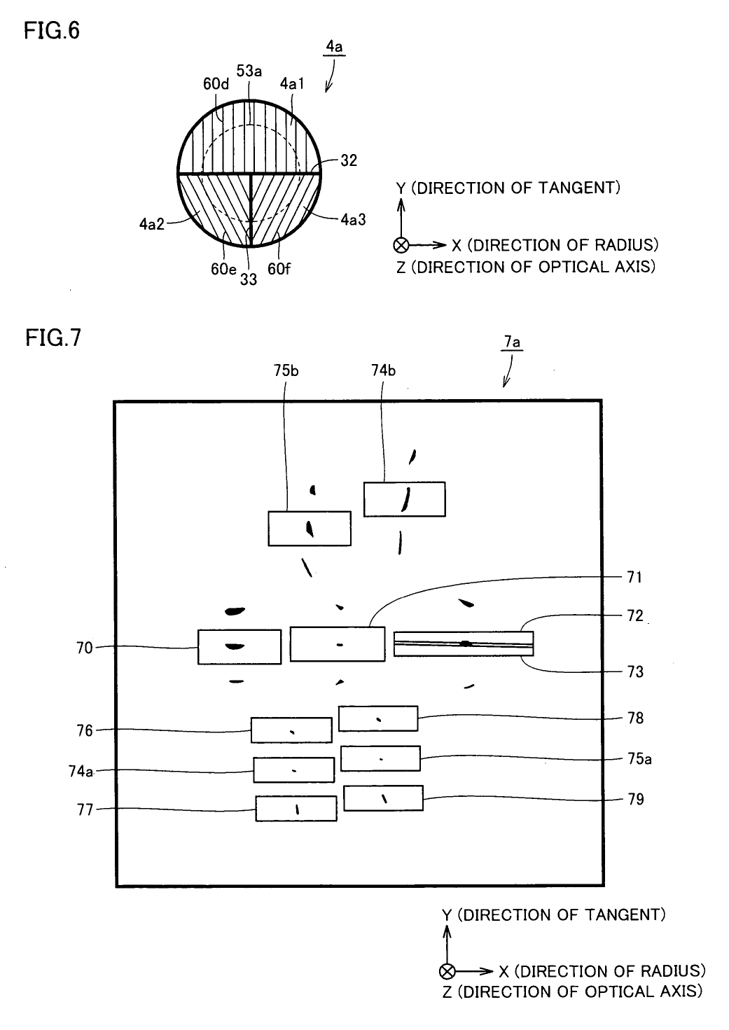

FIG. 6 is a plan view of polarization hologram 4a serving as the second polarization separation means. As shown in FIG. 4, polarization hologram 4a is provided to further separate +1st-order diffracted beam 2a of polarization hologram 2. Polarization hologram 4 includes a first line 32 extending parallel to direction X and a second line 33 extending parallel to direction Y. Polarization hologram 4a is in the form of a circle as seen in a plane. The first line 32 extends to correspond to the circle's diameter and the second line 33 extends to correspond to the circle's radius.

Polarization hologram 4a is arranged so that the polarization hologram 2 +1st-order diffracted beam 2a arrives on the circle substantially at the center portion. In FIG. 6, a +1st-order diffracted beam arrival area 53a is located in the circle substantially at the center. Polarization hologram 4a is divided by the first and second lines 32 and 33 into diffraction areas 4a1, 4a2 and 4a3 for a total of three areas.

FIG. 7 is a plan view of photodetector 7a. Photodetector 7a has light receiving portions 71-73, 74a, 74b, 75a, 75b, 76-79 formed at portions receiving laser light diffracted and transmitted by polarization hologram 4a and detected to perform focus servo. Light receiving portion 70 is used to detect a magnet-optic signal.

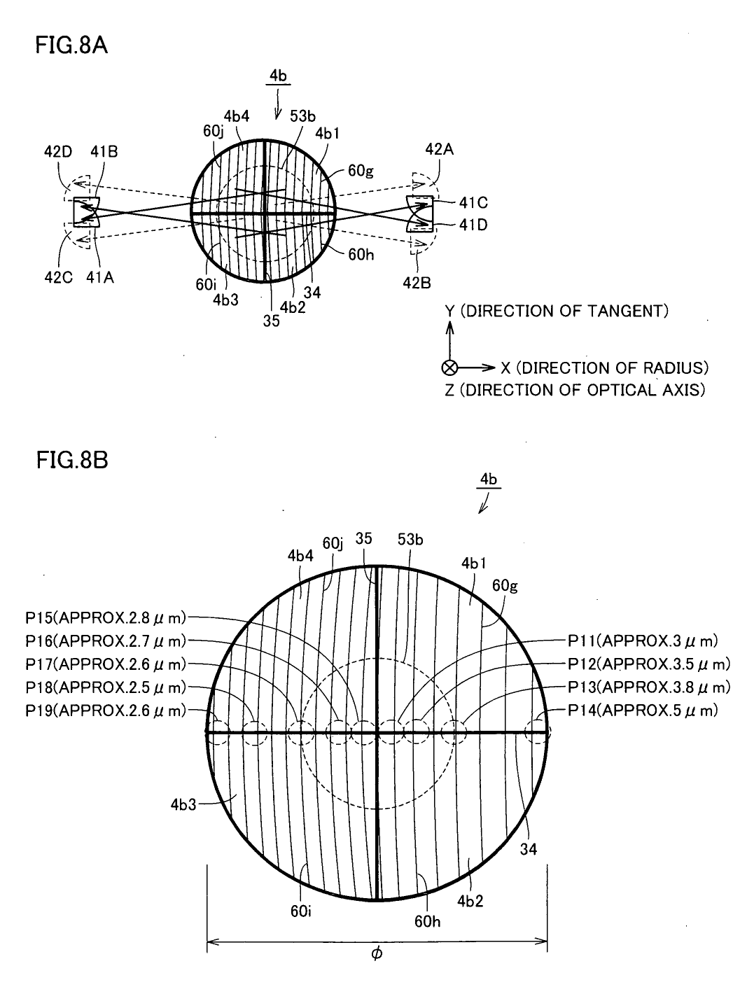

FIGS. 8A and 8B illustrate polarization hologram 4b serving as the second polarization separation means. FIG. 8A is a plan view thereof. Polarization hologram 4b is formed in a circle as seen in a plane. Polarization hologram 4b has first and second lines 34 and 35 to form four diffraction areas. The first line 34 extends parallel to direction X and the second line 35 intersects the first line 34 substantially orthogonally. The second line 35 extends parallel to direction Y.

Polarization hologram 4b is divided by the second line 35 into two diffraction areas, and one of the areas is divided by the first line 34 into the first and second diffraction areas 4b1 and 4b2 and the other of the areas is divided by the first line 34 into the third and fourth diffraction areas 4b3 and 4b4.

The first and second lines 34 and 35 provide an intersection, which overlaps the center of the circle of polarization hologram 4b. In other words, polarization hologram 4b is divided at a main surface thereof by the first and second lines 34 and 35 into substantially four equal portions.

Polarization hologram 4b is arranged such that a main beam of light of −1st-order diffracted beam 2b of polarization hologram 2 arrives substantially at the center. In FIGS. 8A and 8B, a −1st-order diffracted beam arrival area 53b is located substantially at the center of the circle of polarization hologram 4b. The first, second, third and fourth diffraction areas 4b1, 4b2, 4b3 and 4b4 include gratings 60g, 60h, 60i and 60j, respectively.

In the present embodiment gratings 60g and 60h have their respective pitches in symmetry with respect to line 34 and so do gratings 60i and 60j. Furthermore, the gratings 60i, 60j pitch is smaller than the gratings 60g, 60h pitch. In other words, when the second line 35 is seen as a border, one diffraction area's grating has a pitch smaller than the other diffraction area's grating.

Gratings 60g, 60h, 60i, 60j are formed to be substantially parallel to direction Y. It should be noted, however, that the diffraction areas defined by line 35 are each curved to protrude in the negative direction as seen in direction X.

FIG. 8 schematically shows polarization hologram 4b as seen in an enlarged plan view. In the present embodiment polarization hologram 4b is one of polarization holograms studied through simulation. Polarization hologram 4b is formed to be a circle, as seen in a plane, having a diameter φ of 600 μm, area 53b having a radius of 130-150 μm, and an effective NA of 0.135 for reflected light.

FIG. 8B indicates approximate values of pitches of the grating of polarization hologram 4a on line 34 at areas P11-P19. The third and fourth areas 4b3 and 4b4 gratings 60i and 60j have a pitch of approximately 2.6 to approximately 2.8 μm, whereas the first and second areas 4b1 and 4b2 gratings 60g and 60h have a pitch of approximately 3 to 5 μm. Thus gratings 60i and 60j are formed to be smaller in pitch than gratings 60g and 60h.

The first and second diffraction areas 4b1 and 4b2 gratings 60g and 60h have a tendency to have a pitch increased as seen toward the positive direction in direction X. The third and fourth diffraction areas 4b3 and 4b4 gratings 60i and 60j have a tendency to have a pitch generally maintained or increased as seen toward the positive direction in direction X. (Although areas P19 through to P17 provide a slightly decreasing pitch, it is substantially maintained.)

Furthermore at the second line 35 the gratings are interrupted. In each area, however, the corresponding grating is not interrupted. For example, while gratings 60g and 60j are interrupted, gratings 60g, 60h, 60i, 60j in their respective areas are each uninterrupted. Furthermore, at line 34 gratings 60g and 60h are interrupted and at line 34 gratings 60i and 60j are interrupted.

Furthermore within areas 4b1, 4b2, 4b3, 4b4 their respective gratings 60g, 60h, 60i, 60j each have their bars formed substantially parallel to each other in substantially the same direction as the second line 35, similarly as has been described in the first embodiment in connection with a polarization hologram serving as the second polarization separation means.

Polarization hologram 2 is formed to diffract a main beam of light at an angle of approximately −19° (in the negative direction as seen in direction X). The polarization hologram 2 −1st-order diffracted beam is incident on polarization hologram 4b at approximately −19°. Polarization hologram 4b is formed so that the first and second areas diffract the main beam's +1st-order diffracted beam at a setting angle of approximately −34° and the third and fourth areas diffract the main beam's +1st-order diffracted beam at a setting angle of approximately −3.5°. The setting angles are angles relative to a downward direction in FIG. 4 (the negative direction as seen in direction Z).

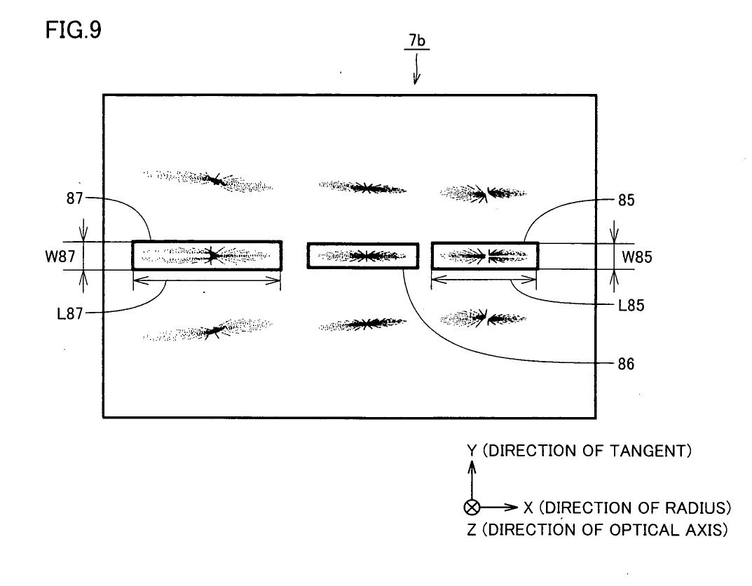

FIG. 9 is a plan view of photodetector 7b. Photodector 7b has light receiving portion 85-87 formed to be capable of receiving transmitted and diffracted beams from polarization hologram 4b that are used to obtain a required signal. Light receiving portions 85-87 are each formed to be substantially square as seen in a plane. Light receiving portions 85-87 are formed to have a length parallel to direction X and a width parallel to direction Y to have margins of 20 μm and 10 μm, respectively, as measured from a spot's end. The length and width margins are introduced as a production error introduced in producing a light receiving portion and that introduced in attaching the light receiving portion to the photodetector are considered.

It should also be noted that FIGS. 7 and 9 show a photodetector as based on the above described optical pickup device's configuration, as fabricated as based on a result of simulation with respect to laser light's behavior, and spots.

In the present embodiment the optical pickup device includes the optical miniaturized module and in addition thereto a collimator lens 17 and objective lens 13, as shown in FIG. 4.

In FIG. 4, the source of light 11 implemented by a semiconductor laser outputs lased light (P polarization) which passes through grating 5 in optical substrate 3 and is thus separated into three beams (a main beam and two subbeams). The subbeams are used to control tracking. The three beams are aligned in a direction (Y) perpendicular to that of the radius of medium 130 as seen when it rotates. In FIG. 4, the three beams are formed in a direction perpendicular to the plane of the figure, and of the three beams, only one beam is representatively shown.

The laser light separated into the three beams passes through optical substrate 1 having polarization hologram 2, collimator lens 17 and objective lens 13 and illuminates medium 130. Medium 130 provides reflects light which in turn passes through objective and collimator lenses 13 and 17 to be incident on polarization hologram 2 serving as the first polarization separation means.

If medium 130 is an optical storage medium having information reproduced in accordance with optical Kerr effect, the reflected light has a polarization plane performed by Kerr-rotation effect in accordance with the information of medium 130. Accordingly, the reflected light slightly has an S polarized component. Polarization hologram 2 is formed to provide a 0th-order diffraction efficiency of 77% and ±1st-order diffraction efficiencies of 11% for P polarization, and a 0th-order diffraction efficiency of 0% and ±1st-order diffraction efficiencies of 44% for S polarization. Polarization hologram 2 has a function apparently multiplying the reflection's Kerr rotation angle.

Polarization hologram 2 provides −1st-order diffracted beam 2b which in turn passes through phase plate 9b and is incident on polarization hologram 4b. Polarization hologram 4 provides transmitted and diffracted beams which are in turn detected by photodetector 7b. Polarization hologram 4b is the second polarization separation means employed to detect a magneto-optic signal and from this polarization separation means' diffracted beam, focusing and tracking error signals are not detected. Polarization hologram 2 provides +1st-order diffracted beam 2a which in turn passes through phase plate 9a and is incident on polarization hologram 4a formed at optical substrate 3. Polarization hologram 4a separates the reflected-light into a transmitted beam and ±1st-order diffracted beams which are in turn detected by photodetector 7a. Polarization hologram 4a is the second polarization separation means employed to detect a magneto-optical signal, a servo signal and the like.

In polarization hologram 2 P and S polarizations have a phase difference (of several tens degrees) caused therein. By arranging phase plates 9a, 9b on optical paths of ±1st-order diffracted beams 2a, 2b of polarization hologram 2, a phase difference introduced in ±1st-order diffracted beams 2a, 2b can be corrected.

Magneto-optic storage media are reproduced in systems, which include a typical, magneto-optic storage medium reproduction system employed for example in mini disk players, Domain Wall Displacement Detection (DWDD) system and the like. If medium 130 is a DWDD magneto-optic storage medium, a phase difference is introduced in P and S polarizations of reflected light. In the present embodiment the optical miniaturized module has photodetectors 7b and 7a detecting −1st-order and +1st-order diffracted beams 2b and 2a, respectively, and each can independently detect a magneto-optic signal. By forming phase plate 9b to correct both the phase difference attributed to polarization hologram 2 and that attributed to the DWDD system, photodetector 7b can detect a magneto-optic signal of the DWDD system while photodetector 7a can detect an ordinary magneto-optic record signal. Thus in the present embodiment the optical miniaturized module allows two magneto-optic signals to be detected by a single unit.

When optical pickup devices perform focus servo, the knife-edge method is often employed as it contributes to reduced crosstalk (or reduced mixing of a push-pull signal). In particular, an optical pickup device that employs a polarization hologram having area 4a1 in the form of a half-moon as shown in FIG. 6, allows a simple configuration to be used to adopt the knife edge method. As such, this method is often employed. The knife edge method requires that reflected light be collected at a light receiving portion of a photodetector.

FIG. 5 diagrammatically shows the polarization hologram 2 +1st-order and −1st-order diffracted beams 2a and 2b collected on the photodetectors. +1st-order diffracted beam 2a is collected to form a spot R201 on the photodetector at a light receiving portion, whereas −1st-order diffracted beam 2b is not collected but rather forms a spot R200 enlarged in area. Thus, polarization hologram 2 having grating 60c curved as shown in FIG. 5 allows +1st-order diffracted beam 2a to be collected on the photodetector.

In FIG. 6, polarization hologram 4a has the half-moon diffraction area 4a1 causing a diffracted beam which is detected to perform focus servo by the knife edge method. Furthermore, quadrantal diffraction areas 4a2 and 4a3 cause diffracted beams which are detected to perform tracking servo.

With reference to FIGS. 6 and 7, the polarization hologram 4a diffraction area 4a1 causes a +1st-order diffracted beam impinging on a line dividing light receiving portions 72 and 73. Diffraction area 4a1 causes a −1st-order diffracted beam impinging on light receiving portion 70. Diffraction area 4a2 or 4a3 causes +1st-order diffracted beam impinging on light receiving portion 74a or 75b, respectively, and −1st-order diffracted beam impinging on light receiving portion 74b or 75b, respectively. The polarization hologram 4a transmitted beam impinges on light receiving portion 71. These spots are related to the main beam of the laser light separated by the grating. For the other two subbeams, diffraction area 4a2 causes +1st-order diffracted beams detected by light receiving portions 76 and 77, respectively, and diffraction area 4a3 causes ±1st-order diffracted beams detected at light receiving portion 78 or 79, respectively.

When a signal output from a light receiving portion formed to receive transmitted light and diffracted light is represented by the light receiving portion's reference character preceded by the letter “S” a magneto-optic signal MO1 can be represented by:
MO1=S71−(S70+S72+S73+S74a+S75a+S74b+75b) (3).

A differential signal between detected signals of light diffracted by the second polarization separation means and that transmitted therethrough can thus be obtained. In the present embodiment a magneto-optic signal detection means is implemented by a signal calculation circuit (not shown) and by this circuit the above-described magneto-optic signal is calculated.

Furthermore, a focus error signal FES is represented by:
FES=S72−S73 (4).

Furthermore a tracking error signal TES1 by detection of a push-pull signal is represented by:
TES1=S74a−S75a (5).

Furthermore, a tracking error signal TES2 by the DPP method is represented by:
TES2=TES1−k{(S76+S77)−(S78+S79)) (6).

Photodetector 7b receiving a beam transmitted through and +1st-order diffracted beams provided by polarization hologram 4b will be described.

As shown in FIG. 8A, polarization hologram 4b has first, second, third and fourth quadrantal diffraction areas 4b1, 4b2, 4b3 and 4b4. Each diffraction area provides a transmitted beam as well as +1st-order diffracted beams. In FIG. 8A, the +1st-order diffracted beam is represented diagrammatically by a solid arrow and the −1st-order diffracted beam by a broken arrow. Furthermore FIG. 8A also diagrammatically shows spots of ±1st-order diffracted beams provided by the diffraction areas.

Spots 41A-41D indicate spots of +1st-order diffracted beams and spots 42A-42D indicate those of −1st-order diffracted beams. In FIG. 8A each spot's profile is represented in the form of a sector in order to clarify which diffraction area of polarization hologram 4b provides a diffracted beam forming the spot. In reality, however, the spot has a complicated profile because of aberration of reflected light and the like. Furthermore, although not shown, light transmitted through polarization hologram 4b impinges between +1st-order and −1st-order diffracted beams. In the FIG. 8A polarization hologram a direction parallel to direction X corresponds to a direction in which transmitted and diffracted beams align on the detector.

Polarization hologram 4b is formed so that spots 41A, 41B of +1st-order diffracted beams by diffraction areas 4b1, 4b2 and spots 41C, 41D of +1st-order diffracted beams by diffraction areas 4b3, 4b4 are diffracted in direction X toward opposite sides with a transmitted beam (not shown) sandwiched therebetween. More specifically, the second polarization separation means or polarization hologram 4b with line 35 serving as a border provides two diffraction areas providing diffracted beams diffracted in opposite directions. Similarly, spots 42A, 42B of −1st-order diffracted beams through diffraction areas 4b1, 4b2 and spots 42C, 42D of −1st-order diffracted beams through diffraction areas 4b3, 4b4 are diffracted in opposite direction, as seen in direction X, with a transmitted beam (not shown) sandwiched therebetween.

Polarization hologram 4b is formed so that spots 41A and 4B partially overlap on the photodetector and so do spots 41C and 41D.

Furthermore, polarization hologram 4b is also formed so that spots 42A and 42B are adjacent to each other on the photodetector and so are spots 42C and 42D.

Furthermore, polarization hologram 4b is also formed so that spots 41C, 41D, 42A and 42B overlap or are adjacent to each other on photodetector 7b and so do or are spots 41A, 41B, 41C and 42D.

Polarization hologram 4b is thus formed so that diffracted beams overlap or are adjacent to each other on opposite sides of a transmitted beam.

Thus, of a set of +1st-order diffracted beams of the first and second diffraction areas, respectively, and a set of −1st-order diffracted beams of the first and second diffraction areas, respectively, at least one set has its two diffracted beams at least partially overlapping at a light receiving portion so that the light receiving portion can receive a small spot.

Alternatively, of a set of +1st-order diffracted beams of the third and fourth diffraction areas, respectively, and a set of −1st-order diffracted beams of the third and fourth diffraction areas, respectively, at least one set has its two diffracted beams at least partially overlapping at a light receiving portion so that the light receiving portion can receive a small spot.

Alternatively, diffracted beams proceeding in their respective directions can be brought to be adjacent to each other so that a light receiving portion can receive a small spot.

Furthermore, polarization hologram 4b is formed so that spots 41A and 41B of +1st-order diffracted beams through diffraction areas 4b1 and 4b2, respectively, arrive at the photodetector after they traverse each other so that they overlap on the photodetector and so do spots 41C and 41D of +1st-order diffracted beams through diffraction areas 4b3 and 4b4, respectively. Such configuration can prevent diffracted beams' spots remote in direction Y so that they can arrive at the photodetector's light receiving portion such that they overlap or are adjacent to each other in direction Y. For example, in direction Y, +1st-order diffracted beams through diffraction areas 4b1, 4b2 can overlap and −1st-order diffracted beams through diffraction areas 4b3, 4b4 can be adjacent to each other and thus arrive.

In the present embodiment polarization hologram 4b is in the form of a circle as seen in a plane. The polarization hologram is however not limited thereto. It is only required to be formed such that the first and second lines provide an intersection substantially overlapping the center of an incident laser beam of light (e.g., a main beam's position).

As shown in FIG. 9, light diffracted by or transmitted through polarization hologram 4b serving as the second polarization separation means arrives at photodetector 7b in approximately nine spots.

A light receiving portion 86 is formed to receive transmitted beams of a main beam and light receiving portions 85 and 87 are formed to receive +1st-order diffracted beams. Light receiving portion 85 receives a spot of diffracted light corresponding to a collection of the FIG. 8A spots 41C, 41D, 42A, 42B overlapping or partially adjacent to each other. Light receiving portion 85 receives reflected light thereof. Light receiving portion 87 receives a spot of diffracted light corresponding to a collection of the FIG. 8A spots 41A, 41B, 42C, 42D overlapping or partially adjacent to each other. Light receiving portion 87 receives reflected light thereof.

As shown in FIG. 9, most of diffracted and transmitted beams are received at light receiving portions such that they overlap or adjacent to each other and thus small. Furthermore, light receiving portion 85 receives three spots, which, however, are not detected separately but rather received at light receiving portion 85 collectively. Such configuration can reduce the number of the light receiving portions and also simplify the configuration thereof It can also simplify the configuration of an arithmetic circuit calculating a signal received from a light receiving portion.

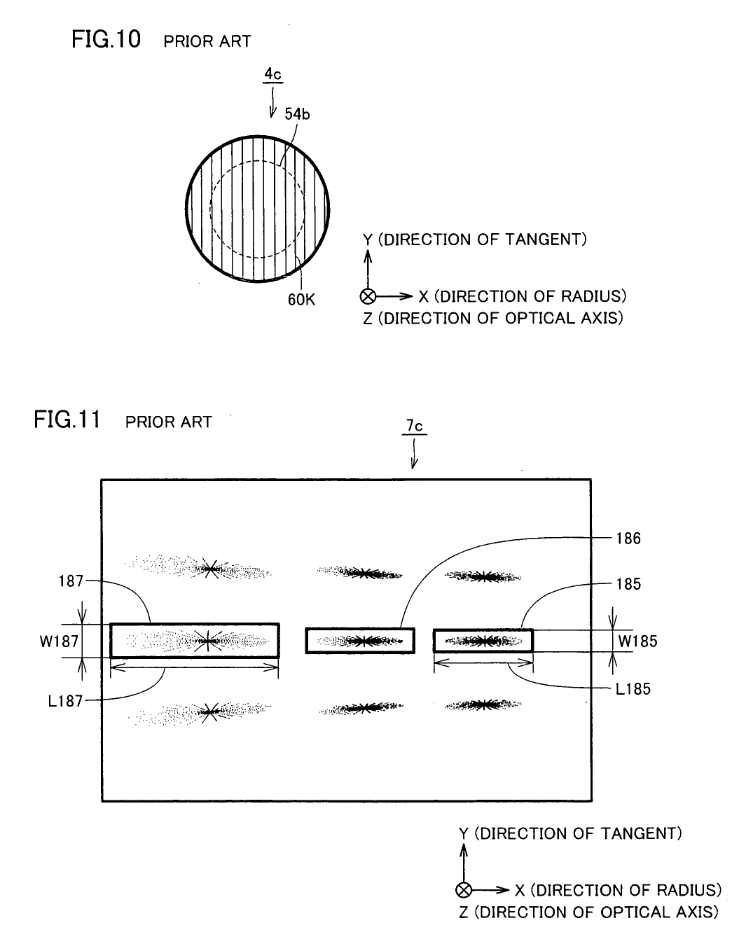

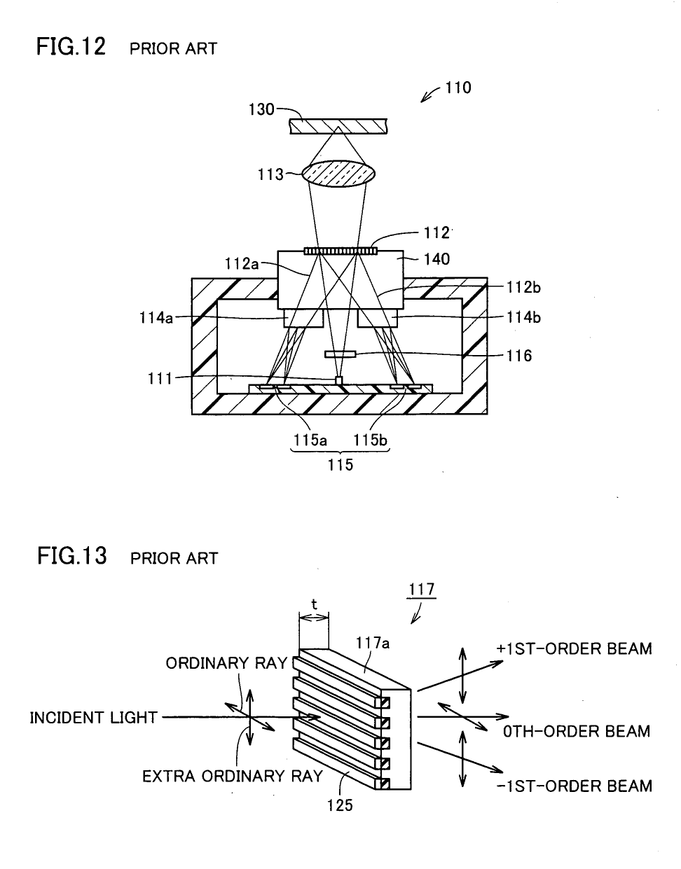

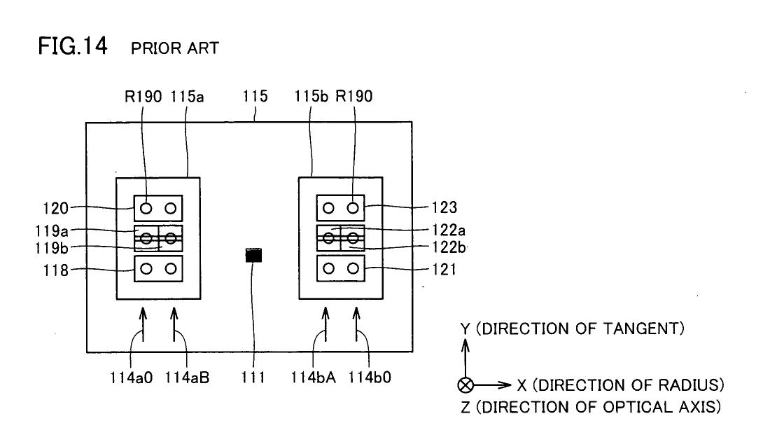

FIG. 10 is a plan view of a polarization hologram serving as the second polarization separation means based on conventional art. A polarization hologram 4c has an undivided diffraction area having a grating 60k with a fixed pitch. Grating 60k is formed of bars each parallel to direction Y. A −1st-order diffracted beam arrival area 54b is located substantially at the center of the circle, as seen in a plane, of polarization hologram 4c.

FIG. 11 is a plan view of a photodetector 7c formed having a light receiving portion formed to correspond to the FIG. 10 polarization hologram 4c in the FIG. 4 optical pickup device. The FIG. 11 photodetector 7c also has a light receiving portion formed as based on a result of simulation. FIG. 11 also indicates spots of transmitted and +1st-order diffracted beams provided through polarization hologram 4c. A light receiving portion 186 receives a transmitted beam of a main beam and light receiving portions 185 and 187 receive +1st-order or −1st-order diffracted beam, respectively. Each light receiving portion is formed to have a length in direction X and a width in direction Y such that margins of 20 μm and 10 μm, respectively, are considered, as measured from a spot's end, as has been described for the FIG. 9 light receiving portion in accordance with the present invention.

The FIG. 9 present photodetector 7b and the FIG. 11 conventional photodetector 7c have their respective light receiving portions having dimensions and surface areas, as shown in Table 2.

TABLE 2

| | Light Receiving | | | | Light Receiving | | |
|---|---|---|---|---|---|---|---|
| | Portion's Length & | | | | Portion's Surface | | |
| | Width (μm) | | | | Area (μm²) | | |
| Present | L85 | W85 | L87 | W87 | 85 | 87 | Total |
| Invention | 213 | 53 | 303 | 58 | 11289 | 17574 | 28863 |
| Con- | L185 | W185 | L187 | W187 | 185 | 187 | Total |
| ventional | 199 | 45 | 340 | 70 | 8955 | 24080 | 33035 |
| Art | | | | | | | |

For each light receiving portion, lengths L85, L87 L185, L87 are indicated as measured in a direction parallel to direction X and widths W85, W87, W185, W187 are indicated as measured in direction Y.

In the present embodiment the second polarization separation means or a polarization hologram can control not only a spot's length but also width to adjust the spot's width. Accordingly, light receiving portions are also compared in width. In Table 2, a spot's length and width are used to calculate a light receiving portion's surface area to compare a conventional light receiving portion and the present light receiving portion. The present light receiving portions 85 and 87 total surface area (of 28,863 μm²) is smaller than the conventional light receiving portions 185 and 187 total surface area (of 33,035 μm²). In particular, a reduction of approximately 13% in surface area can be achieved.

The polarization hologram's transmitted light is received at light receiving portions 86 and 186, which are not indicated in Table 2 as their respective spot sizes and their own sizes do not have a substantial difference.

Thus the second polarization separation means of the present invention allows a light receiving portion to have a reduced surface area and a photodetector to be miniaturized. Furthermore, the light receiving portion's reduced surface area can contribute to an improved C/N.

When a signal output from each light receiving portion shown in FIG. 9 is represented by the light receiving portion's reference character preceded by the letter “S” then a magneto-optic signal MO2 detected including a magneto-optic signal in the DWDD system is represented by:
MO2=S86−(S85+S87) (7).

Thus a differential signal of diffracted and transmitted beams provided through the second polarization separation means are calculated to calculate a magneto-optic signal. The operation is performed by magneto-optic signal detection means (not shown).

Note that light receiving portions 85 and 87 receive all +1st-order diffracted beams, and an unbalance with a quantity of light of transmitted light received at light receiving portion 86 can be reduced and common mode noise can sufficiently be reduced.

In the present embodiment the second polarization separation means or polarization hologram 4b is formed in symmetry with respect to the first line. However, it is not limited thereto and may have a grating formed for each of four diffraction areas defined by the first and second lines.

The present embodiment's optical miniaturized module is applicable for example to an optical pickup device employing an MO disk and can achieve an effect similar to that described above.

The other function and effect are similar to those of the optical miniaturized module and optical pickup device of the first embodiment.

The present invention can provide an optical miniaturized module and optical pickup device capable of controlling a position, profile, length or width of a spot of reflected light at a light receiving portion. The present invention can also provide an optical miniaturized module and optical pickup device capable of providing improved C/N of a magneto-optic signal.

Although the present invention has been described and illustrated in detail, it is clearly understood that the same is by way of illustration and example only and is not to be taken by way of limitation, the spirit and scope of the present invention being limited only by the terms of the appended claims.

1. A magneto-optic, optical miniaturized module comprising:
a photodetector having a plurality of light receiving portions to receive light reflected by a magneto-optic storage medium;
first polarization separation means for separating said reflected light and lasing light output from a source of light and traveling toward said medium; and
second polarization separation means for receiving said reflected light from said first polarization separation means to diffract at least a portion of said reflected light and guide diffracted light to said photodetector, said second polarization separation means including a diffraction element having a plurality of diffraction areas, said diffraction element being formed to diffract said reflected light through said diffraction areas in different directions, said diffraction element being formed such that two of said diffraction areas provide diffracted beams directed to one of said light receiving portions.

2. The module of claim 1, wherein:
said diffraction element includes first and second diffraction areas; and
said diffraction element is formed to allow both of +1st-order diffracted beams of said first diffraction area, both of +1st-order diffracted beams of said second diffraction area, and transmitted beams provided through said first and second diffraction areas to align on said photodetector substantially in a straight line.

3. The module of claim 1, wherein:
said diffraction element includes first and second diffraction areas; and
said diffraction element is formed such that of a set of a+1st-order diffracted beam of said first diffraction area and a −1st-order diffracted beam of said second diffraction area and a set of a −1st-order diffracted beam of said first diffraction area and a +1st-order diffracted beam of said second diffraction area, at least one set has its two diffracted beams at least partially overlapping at said light receiving portion.

4. The module of claim 1, wherein said diffraction element is divided by a line into two areas one having a grating smaller in pitch than the other's grating, said gratings being formed substantially along said line and curved to be concave or convex as seen in a direction from said one to said other areas.

5. The module of claim 1, wherein:
said diffraction element includes first and second lines orthogonal to each other; and
said second line defines two diffraction areas, one being further divided by said first line into first and second diffraction areas, and the other being further divided by said first line into third and fourth diffraction areas.

6. The module of claim 5, wherein said diffraction element is formed such that of a set of a +1st-order diffracted beam of said first diffraction area and a +1st-order diffracted beam of said second diffraction area and a set of a −1st-order diffracted beam of said first diffraction area and a −1st-order diffracted beam of said second diffraction area, at least one set has its two diffracted beams at least partially overlapping at said light receiving portion.

7. The module of claim 5, wherein said diffraction element is formed such that of a set of a +1st-order diffracted beam of said third diffraction area and a +1st-order diffracted beam of said fourth diffraction area and a set of a −1st-order diffracted beam of said third diffraction area and a −1st-order diffracted beam of said fourth diffraction area, at least one set has its two diffracted beams at least partially overlapping at said light receiving portion.

8. The module of claim 1, wherein said diffraction element includes a polarization hologram.

9. The module of claim 8, wherein said polarization hologram has a grating at least partially curved.

10. The module of claim 1, wherein said photodetector is formed to receive at one of said light receiving portions one of beams transmitted through said second polarization separation means and ±1st-order diffracted beams corresponding to said one of the beams transmitted through said second polarization separation means.

11. The module of claim 1, comprising magneto-optic signal detection means for obtaining a differential signal between a detected signal of a diffracted beam of said second polarization separation means and a detected signal of a beam transmitted through said second polarization separation means.

12. A magneto-optic, optical pickup device comprising:
an optical miniaturized module; and
an objective lens, said optical miniaturized module including
a photodetector having a plurality of light receiving portions to receive light reflected by a magneto-optic storage medium,
first polarization separation means for separating said reflected light and lasing light output from a source of light and traveling toward said medium, and
second polarization separation means for receiving said reflected light from said first polarization separation means to diffract at least a portion of said reflected light and guide diffracted light to said photodetector, said second polarization separation means including a diffraction element having a plurality of diffraction areas, said diffraction element being formed to diffract said reflected light through said diffraction areas in different directions.
